(19) United States
(12) Patent Application Publication
(10) Pub. No.: US 2026/0256646 A1
(43) Pub. Date: Sep. 3, 2026

(54) DEVICE FOR USE FOR MASSAGING AN EXTREMITY OF A PATIENT

(71) Applicant: VENEGAS CARRENO UND VAYDA GBR, Muenchen (DE)

(72) Inventors: Daniela Carolina VENEGAS CARRENO, Muenchen (DE); Philippe Giacomo VAYDA, Muenchen (DE)

(21) Appl. No.: 18/866,688

(22) PCT Filed: May 17, 2023
(86) PCT No.: PCT/EP2023/063291

§ 371 Date: Nov. 18, 2024

(30) Foreign Application Priority Data
May 17, 2022 (DE) 10 2022 112 300.6
Jul. 13, 2022 (DE) 10 2022 117 487.5

(51) Int. Cl. A61H 23/02; A61H 9/00

(52) U.S. Cl. CPC A61H 23/02; A61H 9/005; A61H 2201/0103; A61H 2201/02; A61H 2201/165; A61H 2201/5002; A61H 2201/5048; A61H 2205/065; A61H 2205/067

(57) ABSTRACT

The present invention relates to a device for use in arthritis, osteoarthritis, chronic inflammation and/or for reducing muscle pain and muscle tension with respect to a limb or body part (for short: limb) of a patient, wherein the device comprises the following: a casing configured to receive the limb, or a part thereof, of the patient; at least one pressure element for applying, preferably variable or varying, force or pressure to the limb during use of the device; and a control device for prompting force or pressure to be applied to the limb by the pressure element.

### CROSS-REFERENCE TO RELATED APPLICATIONS

This application is a U.S. national stage entry of international application no. PCT/EP2023/063291 filed on May 17, 2023, and claims priority to and the benefit of German application no. 10 2022 112 300.6 filed on May 17, 2022 and German application no. DE 10 2022 117 487.5 filed on Jul. 13, 2022, the entire contents all of which are incorporated by reference herein.

### FIELD OF THE INVENTION

The present invention relates to a device for use in arthritis, osteoarthritis, chronic inflammation and/or for reducing muscle pain and muscle tension with respect to a limb of a.

### BACKGROUND OF THE INVENTION

Devices for use in arthritis, osteoarthritis, chronic inflammation, e.g., in the area of the fingers of a patient are known from the prior art.

### SUMMARY OF THE INVENTION

It is an object of the present invention to provide a further device for use in arthritis, osteoarthritis, chronic inflammation and/or for reducing muscle pain and muscle tension with reference to a limb of a patient.

The object according to the present invention is achieved by the device having the features as described herein.

A device is proposed by the present invention, which may be provided for use, for example, in arthritis, osteoarthritis, chronic inflammation and/or for reducing muscle pain and muscle tension. Said use is provided, e.g., with reference to a limb of a patient, respectively. The use of the device according to the present invention in the rehabilitation of stroke patients and before or after a surgery is also encompassed.

The device according to the present invention comprises a casing which is configured for holding the patient's limb, for example, for receiving the hand, thigh (for example for preventing or treating thrombosis) or foot, or a part thereof. Alternatively or additionally, the casing may also be provided to be applied or put on another limb of the patient. Further alternatively, the casing is a covering for at least a part of the patient's body, e.g., the patient's neck, shoulder, etc. Thereby, the casing may be closed or will be closed in at least one cross-section, such as e.g. a sleeve, a trouser leg or the like, or not, such as e.g. a cloth, a pad, etc.

At least one pressure element for applying, preferably variable, force and/or, preferably variable, pressure to the limb when using the device is also comprised by the device according to the present invention.

Further, the device according to the present invention comprises a control device for prompting, e.g., by causing the pressure element, to exert, in use, force or pressure on the body, e.g., on the limb, or parts thereof respectively. In several embodiments, the control device is arranged in order to determine or change the amount of pressure or force being applied.

Embodiments according to the present invention may comprise some, several or all of the following features in any combination, unless the skilled person considers the combination to be technically impossible.

In all of the following statements, the use of the expression “may be” or “may have” and so on, is to be understood synonymously with “preferably is” or “preferably has”, and so on respectively, and is intended to illustrate embodiments according to the present invention.

Whenever numerical words are mentioned herein, the person skilled in the art shall recognize or understand them as indications of numerical lower limits. Hence, unless this leads to a contradiction evident for the person skilled in the art, the person skilled in the art shall comprehend for example “one” (or “a/an”) as encompassing “at least one”. This understanding is also equally encompassed by the present invention as the interpretation that a numerical word, for example, “one” (or “a/an”) may alternatively mean “exactly one”, wherever this is evidently technically possible in the view of the person skilled in the art. Both of these understandings are encompassed by the present invention and apply herein to all used numerical words.

Whenever reference is made herein to spatial information, such as “top”, “bottom”, “left” or “right”, the skilled person understands this to mean the arrangement in the figures attached hereto and/or during use of the device. “Bottom” is closer to the geocenter or to the lower edge of the figure than “top.”

Advantageous developments of the present invention are each subject-matter of the embodiments.

Whenever an embodiment is mentioned herein, it represents an exemplary embodiment according to the present invention which is not to be understood as limiting.

When it is disclosed herein that the subject-matter according to the present invention comprises one or several features in a certain embodiment, it is also respectively disclosed herein that the subject-matter according to the present invention does, in other embodiments, likewise according to the present invention, explicitly not comprise this or these features, for example, in the sense of a disclaimer. Therefore, for every embodiment mentioned herein it applies that the converse embodiment, e.g. formulated as negation, is also disclosed.

When the term “automated” or “automatic” steps is used herein, this preferably means that a correspondingly programmed control device or a system, e.g., being mostly operator-free, may carry out those steps automatically, i.e. without human intervention, without human involvement and/or without a human making a specific contribution to the implementation of the method. Prompting and thus ultimately carrying out these steps is executed through self-control and/or self-control in a closed-loop manner of the control device or the system itself, or prompted by it, e.g. without operator influence, which would or could influence the method or a result thereof. An automatically prompted step may, therefore, be a step that is triggered or initiated by the control device, in particular because it recognizes (e.g. via sensor signals, by reaching a program section, by the occurrence of a predetermined time, because a previous step has been completed, etc.) that the said step is now pending and its execution is therefore initiated or triggered by the control device.

“Automated” or “automatic” is in some embodiments the opposite of “manual”, wherein “manual” is, or comprises, an activation or prompting of the steps, by a human, e.g., by touching a switch, a touch screen surface or the like, performing predetermined gestures, usually using their hands, a body movement, their voice, and/or by their presence, e.g. in front of a camera, in front of a motion sensor, etc.

If at least one of the steps, for example the first step of a method, is triggered or influenced by a human, or if human intervention, for example an input, is necessary during the method, this may be referred to as a “semi-automatic” method, provided that the remaining method steps continue to run without human intervention, as explained above.

When “programmed” or “configured” is referred to herein, these terms may be interchangeable in some embodiments. “Programming” or “configuring” may in this context encompass creating or compiling software (programs, such as drivers or the like) in advance, e.g. at the factory, or e. g. defined by the technician or programmer, by which hardware components may communicate or may be controlled or actuated.

In certain embodiments, the terms “programmed” or “configured” additionally encompass an adaptation of the one or more device(s) (hardware and/or software) to the requirements of the system and/or to those of the user by selecting suitable software components and/or hardware components of an already existing system or by adding further suitable software components, respectively taking into account the technical object to be achieved.

When herein a control device is mentioned, it may be designed as a closed-loop control device.

When a signal connection or communication connection between two components is mentioned herein, this may be understood to mean a connection that exists during use. It may also be understood that a preparation for such a (wired, wireless or otherwise implemented) signal connection exists, for example by coupling both components, for example by pairing, etc.

Pairing is a process that takes place in connection with computer networks in order to establish an initial link between computer units for the purpose of communication. The best-known example of this is the establishing of a Bluetooth connection, by which various devices (e.g. smartphone, headphones) are connected to each other. Pairing is sometimes also referred to as bonding.

In some embodiments of the device according to the present invention, the casing is a glove having one, two, three or more fingerstall(s) for the patient to wear.

In several embodiments, one or more of the fingerstalls is open at the distal end thereof with respect to an exterior of the glove. A fingerstall open in this way is not, or does not comprise, the pouch section known, for example, from ski gloves, in which the distal phalanx or phalanx distalis together with the fingertip usually comes to rest; in contrast to such closed fingerstalls, the fingerstall open at its distal end ends before reaching the fingertip, which protrudes distally from the glove uncovered by the fingerstall.

This is particularly advantageous in that the haptic perception of the fingertips is maintained or not restricted, for example, in order to be able to operate a device, e. g. a coffee machine, a computer keyboard, a smartphone, a touchscreen or the like, while the device according to the present invention is in use, i.e. while it is being worn or put on and/or while it exerts pressure on the patient's hand and fingers.

In some embodiments, the device according to the present invention comprises at least one tensioning element or adjusting element, for example for varying at least one cross-sectional area of at least one of the fingerstalls.

In several embodiments, the device according to the present invention alternatively or additionally comprises tensioning or adjusting elements on other parts thereof, for example to be able to vary the cross-sectional area of the device on the palm, the wrist, the lower leg, the ankle or another part of the patient's body.

In certain embodiments, a tensioning element or adjusting element may be, or comprise, a strip of material, for example similar to a webbing strap, which is optionally guided through a connecting loop, for example similar to a buckle or a belt buckle, and/or such a connecting loop.

A strip of material or a connecting loop may be placed or provided at any point on the device according to the present invention, in particular on a pressure element, preferably at opposite ends of a pressure element. The material strips may each have different angles to an imaginary axis of the pressure element and/or run parallel to such an axis. Preferably, the angles of the positions of the connecting loops are arranged correspondingly, e.g. in opposite directions, or vice versa. Such an arrangement may advantageously reflect or take into account the anatomy of the body part to be treated.

In several embodiments, one connecting loop is provided per material strip, in others not. By passing the strip of material through the connecting loop and in this way closing, tightening or applying tension to the tensioning element or adjusting element, the pressure element may be fastened or closed, for example, so that it surrounds the body part to be treated; a vibration system as described herein can be fixed, and/or the casing can be adjusted.

Thus, the device or parts thereof may be individually adapted to the patient during use. Differences in the dimensions of the patient's limbs, for example from a wearing time to another, e.g. in the form of swelling, deformation, weight loss or the like, may also be taken into account in this way, which may benefit wearing comfort.

In some embodiments, the possibility to open the tensioning or adjusting elements completely or sufficiently wide may be provided in order to apply little or no pressure to the patient's body at certain points.

In some embodiments, some or all of the tensioning or adjusting elements, for instance at their loose ends, e.g. at the end of the material strip, have sections with a thicker material thickness and/or with a wider geometry. In particular, these sections may advantageously serve to prevent the tensioning or adjusting element from slipping through the connecting loop. In these embodiments, the tensioning or adjusting elements may be opened sufficiently wide, but not completely.

In certain embodiments of the device according to the present invention, the pressure element is, or comprises, a main air cushion.

The optional main cushion may be provided as releasable from the other components of the device. The same may apply to optional secondary air cushions, for example finger air cushions. This allows the device to be used in a wide range of applications, e.g. with or without the use of pressure, such as air pressure. The designations secondary air cushion and finger air cushion may be interchangeable in some embodiments.

In several embodiments, the material strips at one end of the main air cushion may be provided to be fixed to a ledge or to a strip or the like, for which a counterpart for closing is provided at the respective opposite end of the main air cushion, for example as with a hook-and-loop fastener. Such a ledge, such a strip or the like may advantageously help to close the main air cushion with just one hand movement and to fix it to the part of the body to be treated.

In addition, such a tensioning element or adjusting element may be used to increase the desired pressure on the patient's body by adjusting it to be tight or snugly fitting.

In several embodiments, the tensioning element or adjusting element (in short: element) is elastic, in others it is not.

In embodiments with an elastic tensioning element or adjusting element, accidental overloading, e.g. of the finger, may be effectively prevented in a corrective manner. Furthermore, such embodiments may prevent pressure overload, for instance when bending joints of the treated body part, due to the ability of the elastic element to yield elastically.

In embodiments with one (or more) non-elastic tensioning elements, pressure conditions, for example on a desired or specific finger, etc., may be adjusted in a more targeted manner.

In some embodiments, at least one of the fingerstalls is not closed along its longitudinal direction in every cross-section.

In several embodiments, at least one of the fingerstalls is not closed circumferentially along its longitudinal direction in at least one cross-section (in others, however, it is). It may be provided that the fingerstall in these embodiments does at least not completely cover the circumference of the finger received therein along the circumference of the finger.

Associated advantages may include that the skin is allowed the greatest possible contact with the atmosphere. Sweating due to wearing the device is therefore, as far as avoidable, counteracted.

In addition, this design may also make the use of the device helpful for patients with, in some cases, only temporarily swollen fingers or joints.

Furthermore, such a design may advantageously be used by a large number of persons or patients, regardless of, e.g., their natural finger circumference, etc. In this way, it may be sufficient to keep the number of different sizes for the device low, or even to provide only one standard size of the device.

In some embodiments of the device according to the present invention, the casing is a sock, in others a glove or a sleeve.

In some embodiments of the device according to the present invention, the at least one pressure element is a compressed air system or is encompassed by such a system. Thus, the pressure element may be an inflatable element and/or an element that is displaceable or shiftable by compressed air.

In order to adapt well to the patient's limb, the pressure element can be ergonomically designed. For example, in areas where the patient should still be able to bend their joints when using the device, e.g. at the base joints of the fingers, at the wrist, at the knee, etc., it may have suitable recesses and/or shapes especially provided for this purpose, for example by a convex or otherwise curved edge of the pressure element in the direction of the fingers. In the example of a glove, the convex edge of the palm towards the fingers may be traced by the shape of the pressure element.

Through-openings may be provided through the device or through components thereof, e.g. through the main air cushion.

At least one optional through-opening may be provided in the center, or a central section, of the section of the pressure element coming to rest on the palm or at a different place thereof. It may make it easier or even possible to bend the fingers, for instance when closing the hand. A recess in the pressure element in the direction of the wrist may advantageously maintain the free flexion and rotation of the same when using the device.

Any shape and design of the outer edges and/or through-openings of the pressure elements which is suitable for maintaining the patient's freedom of movement is conceivable at this point and is respectively encompassed by the present invention.

In several embodiments, at least one pressure element lies on the palm of the hand; in certain embodiments, it may extend further to the back of the hand.

A compressor, an air pump or the like may be provided to be controlled by the control device in order to build up air pressure.

In certain embodiments, a suction device may be provided for building up a negative pressure in the pressure elements. In several of these embodiments, the negative pressure causes the material of the pressure element to shorten and thus exert pressure on the limb.

In some embodiments, the compressed air system comprises an inlet valve and an outlet valve, each optionally in communication with the atmosphere. In certain embodiments, no inlet valve is provided.

In several embodiments, the inlet valve and outlet valve are provided to be actuated, in particular opened or closed, by the control device.

In several embodiments, the control device is configured to activate the provided pressure elements, air cushions, vibration motors or vibration elements, etc., or combinations thereof, according to a predetermined scheme. In such an exemplary scheme, e.g., one or several comparatively more distally located components are activated first, followed by activation of one or several comparatively more proximally located components. This may lead to a massage in the direction of the trunk, i.e. in a proximal direction. Such a coordinated activation may be perceived as a massage. The direction in which the effects of the individual components alternate or their temporal starts follow one another may be towards the heart, which may promote venous drainage; other directions, in particular away from the heart, may also be prompted by the appropriately configured control device.

If several air cushions are provided, it may be provided to activate at least two of them (e.g. main air cushion and finger air cushion) in succession.

In some embodiments, the pressure element is, or comprises, a vibration system or parts thereof. The device may be configured to use, at least intermittently in certain modes, either the vibration system as the sole pressure element, or in combination with another pressure element, which may be e.g. air-pressure controlled, for example as also disclosed herein.

The vibration system exerts pressure on the skin and underlying tissue, e.g., by friction or other interaction created by the application of a vibrating vibration motor or, generally, vibration element. Stimulation such as one generated by vibration is also understood herein as pressure.

In several embodiments, the vibration system comprises vibration motors.

In some embodiments, the vibration motors are releasably connected to the control device and/or the voltage source by conductors, e.g. electrically conductive yarn, and two connectors and can be released from it.

In several embodiments, it is possible to arrange some or all of the vibration motors at any positions of the device according to the present invention in order to be able to define individual massage points.

In some embodiments, some or all of the vibration motors are arranged on the side, preferably only there, of the casing facing the palm of the patient's hand during use.

In several embodiments, the vibration motors press against the palm of the user's hand when the device is in use.

In some embodiments, the pressure on the body part to be treated is changed over time through a pressure change in the pressure element such that a massage effect is achieved.

In certain embodiments, a massage is achieved only by vibration motors.

In several embodiments of the device, the pressure element is arranged in a pocket of the casing or is otherwise surrounded on both sides by casing material and/or a textile.

In these embodiments, the pocket, the casing material and/or the textile is/are in particular non-conductive, for example cotton, elastane or the like or combinations of such materials.

In some embodiments of the device, electrically conductive yarn is provided for electrically supplying the pressure element, vibration system or control device, in others it is not provided.

In several embodiments of the device, the pressure element is realized by, or comprises, a material which shortens in length depending on the current or voltage applied thereto. The pressure effect may thus be generated by shortening the material accordingly.

In some embodiments of the devices, one or more pressure elements are arranged in the device at locations which, in use, come to lie over or on joints of the patient, e.g. finger joints, wrist joints, knees, etc.

In certain embodiments, the pressure elements lie under the casing and are, therefore, not visible from the outside during use. They may lie between two layers of the casing and/or of a textile.

In several embodiments of the device, different modes for operating the pressure element may be selected by the control device.

In some embodiments of the device, the control device is releasably connected to other components of the device, such as e.g. the motor, the pump, or the like, by a plug connection.

In certain embodiments, the control device is connected to the casing by fastening loops or fastening straps or other fastening devices and may, therefore, also be released from the casing.

This makes it possible to separate the device from the control device (or vice versa) and to wash it for example without electrical components such as a voltage source and/or control device, etc. The vibration motors may, in several embodiments, be provided to be a non-releasable part of the device. Tests have shown that they can remain in or on the device during a washing process. In other embodiments, they are a releasable part of the device. They may be provided for their removal from, e.g., a textile layer.

Further advantages may be that the control device may be easily replaced by a successor version thereof, should this be the case. Replacement is also possible in the event of a defect. The charging process may also be simplified. It is also easily possible to deliver the device with an individualized control device, and the access to the control device, for instance in order to install software updates, could also be simplified. Regardless of whether the control device is provided to be separable or not, in several embodiments it may be prepared to be updated or customized via software updates.

In several embodiments of the device, the casing is elastic and/or waterproof, at least in sections.

In certain embodiments, the casing is breathable. This means that skin respiration is not, or only slightly, impaired, which may benefit wearing comfort.

In some embodiments, the casing has loops, pockets or the like which may be accessed with the hand which is not received in the device or with fingers thereof, before, during or after use of the device. These are also referred to herein as pull loops.

In particular, these may serve for easier taking off and/or removing (of) the device according to the present invention from the patient's limb, for example by pulling them, such as with a finger.

In several embodiments of the device according to the present invention, some or all of the pneumatic and/or electrical supply lines for the at least one pressure element are, when in use, protected via textiles or parts of the casing from contact with the skin of the part of the patient's body treated by the device.

In some embodiments of the device, the device further comprises a heating and/or cooling system. An energy source may be provided for this purpose.

In some embodiments, a heating system is realized by first heating the air that is conveyed into the pressure elements. In several embodiments, heating is provided by electrical energy. In some embodiments, cooling is achieved through the cooling system by regularly or continuously exchanging air in the pressure element with e.g. ambient air.

In some embodiments, heating or cooling devices are provided which work on a chemical, or other, basis and which need to be activated, for instance, by pressing or breaking sections thereof. These may be based on the principle of hand warmers. This means that they consist of a sturdy plastic bag containing a supersaturated sodium acetate (C₂H₃NaO₂) solution and a metal plate. When the metal plate is bent, the solution is stimulated to crystallize and release heat.

Heat reservoirs or latent heat reservoirs or cold reservoirs or latent cold reservoirs that can be e.g. pre-tempered before they can be inserted e. g. into a pocket of the device may likewise be provided. Pockets, insertion possibilities etc. may be provided on the device or a part thereof.

In several embodiments, the device, in particular its control device, is in wired or wireless signal communication (e.g. via Bluetooth, WLAN, etc.) to another device or unit, for example of the patient, of a caregiver, of a doctor or the like. Such a device may be or comprise, for example, a smartphone, a tablet, a smartwatch or the like. This further device or unit may, e.g., serve to operate the device, its control device, valves, etc. An operating interface for the patient to operate the device may therefore be provided on the device, but need not be. For example, such an interface may be completely relocated to the smartphone as an example of such a further device, on which sufficient space may be created for the operating elements such as switches, touch surface(s), etc. without being spatially limited for this purpose, e.g. by the size of the device carrying the switches, etc. Optionally, parts or aspects of the operation may be relocated to the further device, but certain operating options, such as the basic ones, may still be provided at or on the device itself.

In some embodiments, such further devices may also serve to provide information to the patient or third parties, for example, duration and/or intensity of use may be captured, recorded and stored, for instance by the device itself, and then retrieved or output.

In several embodiments, such further devices may also serve documentation purposes, for example how often and/or at what intensity the device has been used in a certain period of time.

In some embodiments, such further devices may enable input from patients, medical staff or caregivers, for example to document a massage success, patient condition, settings of the device for further treatment or the like.

In some embodiments, such further devices may additionally be used, for example to inform the patient about the operation of the device according to the present invention, for example by playing tutorials on such a further device or by retrieving them.

In several embodiments, such further devices may additionally serve for communication between different patients using the device according to the present invention. They can, in the form of an organized and/or social network of patients interacting with each other (community), for example, exchange experiences or help each other via the further devices.

Light sources, such as for example LEDs, OLEDs, lamps or the like, may be provided on the device in several embodiments in order to visually indicate operation or an operating mode (e.g. by a light source of a specific color), to indicate the state of charge of a rechargeable battery, a battery, etc., to indicate the way the pressure is generated at the specific moment (compressed air, vibration, etc.) and/or the like. Such displays may also be shown, e.g. as a light source, button, icon, etc., on the further device, which may be connected wirelessly to the control device.

In some embodiments, it may be provided that light sources, buttons, icons, etc. indicate an alarm event, for example a malfunction.

In several embodiments, the device comprises a connecting device to a voltage source, such as a socket for a plug. In some embodiments, the device is connected to a voltage source. The voltage source may be a rechargeable battery, a battery, etc. It may be part of, e.g., a laptop, a smartphone, the power line of the house, etc., to which the device is connected, e.g., by cable and, for example, USB interface.

In some embodiments of the device, the control device may be, or comprise, a pluggable control unit.

In several embodiments, the control device may comprise a printed circuit board with programming.

In some embodiments, the circuit board of the control device may comprise two boards, preferably a first board configured or programmed for internal control and a second board configured or programmed for the user or patient communication, i.e., for controlling the control unit or interface.

In several embodiments, the voltage source, for example the rechargeable battery, may be charged externally, for example at a suitable charging station provided for this purpose.

In some embodiments, the voltage source is charged via a USB port, such as, e.g., a USB-C port, or any other suitable port.

In several embodiments, the voltage source is charged via a magnetic charging connection. Induction may be used here.

In some embodiments, the voltage source is provided in a common housing with the control device. Both can thus be easily separated from the rest of the device, for instance to wash the latter.

In some embodiments, the appearance of the device according to the present invention differs little or not at all from a conventional garment, for example a glove or a sock.

In several embodiments, the control device is adapted to not allow the user or patient to determine or change the amount of pressure or force applied. Alternatively or additionally, the device or control device does not have a corresponding switch, correspondingly designed interface, etc.

In some embodiments, the control device causes, possibly depending on the set mode, the duration during which the air pressure is increased in at least one of the pressure elements, during which the increased pressure is maintained, during which the pressure is reduced again and/or when a renewed increase in pressure is started. This may be done automatically, i.e. pre-programmed, and does not require any action by the user.

In several embodiments, the pressure elements are either configured to apply pressure by means of vibration, or are not configured to apply pressure by means of vibration. In the latter case, pressure may be applied in any other way than vibration.

In some embodiments, the optional loops, which are configured as pull loops to support removal of the device, for instance when the device is designed as a glove, and/or the optional tightening elements, or some of them respectively, are designed from or with hook-and-loop or corresponding material (e.g. Velcro).

In several embodiments, the device comprises LEDs for indicating the state of charge of a voltage source, the set mode, the operating state, etc.

In some embodiments, the device comprises no pressure elements, air cushions nor vibration motors arranged partially, completely or overlapping-on top of each other or stacked on top of each other.

In certain embodiments, air cushions, e. g. the main air cushion, and vibration elements, pressure elements, air cushions and/or vibration motors are present—partially, completely or overlapping—arranged or stacked on top of each other.

In several embodiments, the device is not a neck support nor comprises one.

In certain embodiments, the device comprises resistance coils as a heating element or as a part thereof. In other embodiments, the device comprises no resistance coils.

In some embodiments, the device comprises a plurality of fingerstalls which are connected to each other, e. g. by textile layers of the device.

In several embodiments, the device comprises no paraffin-filled elements or bubbles.

In some embodiments, the device or its casing comprises several layers, e.g. two or more, which are respectively arranged inside each other, e.g. as an inner layer and an outer layer. The different layers may consist of, or comprise, the same or different materials. For example, the inner layer may consist of, or comprise, preferably entirely or substantially, a breathable, skin-friendly material, whereas the outer layer may consist of, or comprise, a different material selected, e. g., for aesthetic reasons, as protection from rain, etc.

In some embodiments, the device comprises vibrating pressure elements only—or predominantly—on one of its sides which, in use, comes to lie, or acts, on the palm side, i.e. palmar, but not also on the back of the hand, i.e. dorsal.

In several embodiments, the device comprises one or more sensors by which patient data may be collected, for example, pulse, heart rate, temperature, blood oxygen and/or the like. Such sensors and their modes of operation are known from the prior art.

In some embodiments, the patient data collected by such sensors may be made accessible to the user, the physician caring for the patient, the physiotherapist and/or other persons involved, e.g., in the treatment of the patient. In these embodiments, the patient data may be provided and accessible as raw data or already processed data. Devices or units required for this, such as computing devices, analysis website, app, software, (secure) cloud, wired or wireless readout device, etc., may be provided as encompassed by the device according to the present invention or separate from it, preferably connected in a signal communication or prepared or programmed for this purpose.

In several embodiments, the software of the device according to the present invention comprises algorithms and analysis techniques (“advanced analytics”) based on artificial intelligence (AI), in particular neural networks, mathematical functions and/or the like. These may encompass, among other things, analyses and calculations based on data collected, e.g. by the sensors, using statistical and/or learning methods.

The term “advanced analytics” may encompass the semi-automatic or automatic analysis of data.

In the context of “advanced analytics”, sophisticated methods and tools from the prior art are used, e.g., regression, clustering, cohort analysis, recommendation algorithms, optimization, for example, Bayesian optimization, gradient boosting (for example the XGBoost library), (decision) tree algorithms, preferably directed and/or non-cyclic, influence diagrams, graphical probability models or the like.

In some embodiments, the term “advanced analytics” encompasses, in particular, methods that make it possible to derive models based on empirically determined data, which methods allow to make assessments and predictions. It may also be provided to develop treatment regimens based on the empirically determined data, which may make it possible, e.g., to suggest the use of the device according to the present invention for treatment, preferably to the specific person. In several embodiments, the device according to the present invention may be programmed to perform such methods.

Alternatively or additionally, a wide variety of “data mining” methods may fall under the term “advanced analytics”. In this, the term “data mining” comprises the—mostly semi-automatic or automatic—evaluation of large amounts of data (which were obtained from, for example, patient collectives that were treated with e.g. the device according to the present invention (e.g. with identical models thereof)) to determine regularities, legalities and hidden correlations that occur, based on which conclusions may be drawn about an expected development, in this case for example the course of the disease. The term “data mining” may in turn be encompassed by, or encompass, the broader process of knowledge discovery in databases (KDD).

In some embodiments, analyses and calculations may be based, in particular, on comparisons with data from other patients, such as patient groups, which may be classified in order to obtain information for the specific patient with regard to diagnosis, prognosis, therapy recommendation, etc.

In several embodiments, the “advanced analytics” comprise algorithms based on neural networks and/or machine learning, in particular “deep learning” and/or “reinforcement learning”.

Neural network architectures may encompass convolutional neural networks (CNNs), long-short-term memory networks, recurrent neural networks, or other types of neural networks commonly used for optimization or classification problems known in the prior art.

In some embodiments, the analysis techniques performed herein may additionally incorporate input from patients, medical staff or caregivers, for example input regarding patient feedback, documentation of a massage success, documentation of a patient condition, for example a pain sensation, documentation of a disease progression or the like. The devices described herein may be used for these inputs.

In several embodiments, the inputs from patients, medical staff or caregivers may be stored and used, for example, to recalculate settings of the device, in particular for further treatment of the specific patient, treatment suggestions or the like. In these embodiments, the results of the “advanced analytics” may alternatively or additionally also be used in the treatment of other patients, in particular with the same or similar clinical picture.

In some embodiments, the further processing of the data collected by the sensors described herein encompasses calculations and analyses based on artificial intelligence (AI) as described above. In some embodiments, artificial intelligence may be used, for example, to determine relationships based on the inputs described above, which in particular allow findings to be made, diagnoses to be made and/or therapy methods to be offered or compared for certain clinical pictures and/or courses of disease, such as for example suitable regimens when using the device according to the present invention.

In several embodiments, the evaluation device can make prognostic statements regarding the course of a clinical picture. This may be done e.g. by comparison with stored reference data, reference courses, by using reference databases, etc. Artificial intelligence may also be used here. Algorithms for data processing and/or data comparison, in particular those based on artificial intelligence as described above, may also be encompassed by the present invention. For example, progression checks may be carried out in this way, a subclassification of the specific condition, evaluations with regard to particularly suitable use of the device according to the present invention and more may be carried out and communicated accordingly if necessary.

As further examples, alarms may be triggered to the above-mentioned persons, e.g. in the event of a low battery level, temperature abnormalities, incorrect use, malfunctions of the device and/or the like. Alarms may be stored in a history and their frequency, triggers etc. may be monitored, in particular to be included in the above-mentioned calculations and analyses.

In several embodiments, the device according to the present invention comprises a unit for audio playback. By this unit, the audio playback may take place at a volume being in particular freely selectable, for example by the user or patient. Acoustic alarms and signals may be emitted by the unit for audio playback, for example in order to draw attention to a defect or disturbance, to indicate the expiry of a timer, etc.

In some embodiments, the device comprises a display or another displaying unit, in particular a touch display, or is in signal communication therewith (or is prepared for such a signal communication, respectively). The displaying unit may through this and through suitable software be provided and/or suitable for enabling the operation of the device according to the present invention, the reading of values (for example the above-mentioned sensor values), the playing of video files (for example tutorials for operating the device), the receiving of notifications (for example local status messages of the device, visual alarms, etc. and/or global messages via the Internet, etc.) or the like.

In several embodiments, the device according to the present invention comprises both a unit for audio playback and a displaying unit. In certain embodiments, it may be provided to be able to connect these units or the device according to the present invention to another external device, for example a smartphone of the patient, or an external storage device, for example a cloud, via signal communication, for example to play video files or audio files (movies, music, audio books, etc.) , to receive or make calls or the like. This may advantageously help to make the time spent using the device according to the present invention as pleasant as possible for the patient.

In some embodiments, the device according to the present invention comprises a microphone through which the device can be operated by voice control. The voice control may operate the same functions as described above for the displaying unit and audio playback, or a selection thereof. In addition, ambient noises may be realized and, e.g., the use of the device according to the present invention may be analyzed.

In several embodiments, the user may program the functions of the device according to the present invention, in particular the massage function, as they wish, e.g. completely freely or, e.g. concerning the end user, only within the framework of permissible programming steps. This may optionally be done analogously on the device itself. Alternatively or additionally, the device may be programmed using an external device, for example a smartphone, computer, tablet, etc.

In some embodiments, a programming of the functions of the device according to the present invention, for example as described above, may alternatively or additionally be provided by third parties, for example by the attending physician, the physiotherapist, by family members providing care or by other persons entrusted with the care or nursing of the patient.

In several embodiments, it may be possible to control the single pressure elements or vibration motors individually. This may enable to subject, e.g., individual fingers to a targeted massage. In this way, previously restricted degrees of movement of the limbs concerned could be regained or an instrument could be learned more easily (e.g. guitar, piano, etc.). Thus, in some embodiments, the use of the device according to the present invention may help to regain motor function of the user's fingers.

In some embodiments, the control device is configured to control one or all of the vibration motors by frequency modulation, and/or the one or all of the vibration motors are frequency modifiable. It may be provided that the controlled vibration motor oscillates or should oscillate at a specific one of several settable or selectable frequencies settable by the user. Additionally or alternatively, this may be such that the control device itself specifies varying frequencies for the vibration, so that the treatment is carried out with a changing frequency or a constant frequency over time as desired.

Furthermore, as also provided in several embodiments, the device according to the present invention may be used to control individual or all fingers, e.g. as when playing a set song or a predetermined melody. The microphone optionally integrated in the glove may be used for this purpose.

In some embodiments, the device according to the present invention comprises a modular structure. This means that one, several or all components may be separated from each other. Thus, in certain embodiments, in particular the components that are in contact with the skin of the part of the patient's body to be treated may simply be washed or cleaned without having to wash other components as well. This design enables a great degree of hygiene.

In several embodiments, a modular structure may contribute to a more variable or more individualized use, for example by allowing individual components (for pressure, vibration, etc.) to be placed on or over certain joints, i.e. fixed there (for example by the tensioning or adjusting elements, as explained herein). This allows an individual, changeable patient-related and/or disease-related massage of individual joints and/or parts of the body. Thus, for example a first pressure element (or another first component) may be provided at a point A today, but at a different point B tomorrow. For example, three pressure elements (or another first component) may be put on today, but more or less than three tomorrow.

In some embodiments of the device according to the present invention, the pressure element consists of, or comprises, a main air cushion and at least one secondary air cushion.

In several embodiments, the main air cushion and the individual secondary air cushions (together for short: air cushions) each have separate lines for supplying air. In certain embodiments, these may be connected to a single pressure source, for example a pump, via a distributor.

Air cushions which are supplied with air (or gas) by separate lines are in some embodiments considered to be fluidically separate from each other.

In certain embodiments, these lines are fluidically connected using connectors being suitable and provided for this purpose via suitable connections on the respective air cushion.

The positions of the connections on the air cushions preferably result from the anatomical conditions.

In some embodiments, the air cushions of the pressure element are made of, or comprise, thermoplastic polyurethanes (TPU).

In several embodiments, some or all of the air cushions of the pressure element are or were made by welding two films together.

In some embodiments, some or all of the air cushions of the pressure element are manufacturable or are manufactured using additive manufacturing, also known as additive method or three-dimensional (3D) printing method. These are available in various forms based on building materials in liquid, viscous, solid or powder form.

Fused filament fabrication (FFF) uses a continuous filament of a thermoplastic material that is applied in molten form to the growing (emerging) workpiece.

Another type of 3D printing method uses building material in powder form that is selectively solidified by sintering, melting, fusing or bonding the powder at selected locations in order to produce elements. These elements are built up by depositing powdered building material layer by layer. An element is thereby formed by depositing a layer of building material in powder form on a building platform and then based on computer-generated data selectively heating or bonding the powder in the parts of the layer that are to become part of the element. For example, the powder may be liquefied or melted by infrared radiation, sintered by a laser beam or bonded by a binding material. The platform is then lowered, another layer of building material in powder form is added and melted, fused or bonded again. These steps are repeated until the element has been produced.

Selective heating may be achieved by a laser beam, such as for example in selective laser sintering (SLS), or by infrared radiation, such as for example in multi-jet fusion (MJF) methods, including high-speed sintering (HSS).

Selectively solidifying may be achieved by binder jetting methods, among others. The main principle of these solidifying methods is the use of a powder that is treated in order to solidify at predetermined locations to yield the element.

Building materials used in additive methods are often polymers, and the quality of the elements obtained in these methods depends on the polymer used.

One class of polymer that is highly desirable for additive manufacturing is polyamide, a very robust polymer that is resistant to environmental influences and comprises good mechanical properties. Therefore, polyamide in powder form is a useful building material and is used in multi-jet fusion (MJF), HSS and selective laser sintering (SLS) methods. Other well-known methods use light to solidify photoreactive liquid resin, for example laser-based stereolithography (SLA) and digital light method (DLP). Another well-known method is multijet modeling (MJM), in which material is heated and “trickled” from nano-jets onto the building platform, cured and hardened with UV light.

Other materials useful in sintering method are thermoplastic polymers such as thermoplastic elastomers, such as, among others, thermoplastic polyurethane (TPU), thermoplastic polyamides (TPA), thermoplastic copolyester compounds (TPC).

In several embodiments, some or all of the air cushions of the pressure element are made of or comprise silicone.

In some embodiments, some or all of the air cushions of the pressure element are manufactured by casting or injection molding.

Due to the way they are produced, the air cushions may advantageously be adapted in size and shape to the respective patient or the part of the body to be treated or may be individualized to this patient or this part of the body.

In several embodiments, an air cushion, for example the main air cushion, comprises layers of different thickness and/or stiffness, wherein, for example, a layer facing away from or furthest away from the patient's skin is thicker and/or has a higher stiffness than a layer facing the patient's skin. For example, the layer facing away from the skin may be, or comprise, a TPU-coated textile, while the layer facing the skin may be, or comprise, a TPU film. A layer of air that builds up between these layers thus causes the lower layer facing the skin to expand more than the upper layer of the pressure element facing away from the patient's skin. This allows the pressure on the patient's hand H to be increased or ensured, while the external dimensions of the device remain almost constant.

In certain embodiments, the pressure system does not comprise nor include foam.

In some embodiments, motors, in particular vibration motors, in particular as disclosed herein, may be arranged between the patient's skin and the layer of the pressure element facing the patient's skin.

In certain embodiments, the motors are releasable components of the device, in particular of the glove, as disclosed herein. The device may be configured to allow one, more or all of the motors to be attached to and releasably connected at different locations on the casing or textile, such as by a correspondingly provided hook-and-loop connection, hook-on connection, slip-on connection, etc.

In several embodiments, some or all of the air cushions do not have a closed circumference and/or no cylindrical shape.

In some embodiments, some or all of the air cushions do not comprise a circumference covering or integrally covering the entire circumference of the body part to be treated. In use, they are therefore not closed around the circumference of the body part.

In certain embodiments, some or all of the air cushions may be provided or worn covering the entire or partial circumference of the body part to be treated or even overlapping themselves.

In several embodiments, the device according to the present invention comprises, e.g. dorsally (i.e. for example on the back of the hand), at least one zipper, hook-and-loop or hook fastener or other fastener. Preferably, one end of the fastener is in the fabric, the other is preferably at the edge. Protection of the patient's skin from contact with the zipper, for example by protruding fabric or material, may be provided in certain embodiments. The zipper may be provided to allow the device according to the present invention to be put on or taken off comfortably. The casing may comprise a slit which allows the entry opening to be widened, for e.g. the hand, and which may then be closed by the fastener.

In several embodiments, the device does not have a bandage or sleeve, in particular one that is easier to stretch circumferentially than longitudinally during use.

In some embodiments, the device is not for application to an elbow.

In several embodiments, the control device of the device is not configured to perform or to be able to perform a pressure increase to a peak amplitude of at least 1000 Pa within one second or less.

In some embodiments, the device does not comprise bellows, in particular two bellows, as a pressure source.

In several embodiments, the pressure element, e.g. an air cushion, such as the main air cushion, comprises a plurality of sections, e.g. optionally two or more first sections and one or more second or further sections. The sections give the pressure element an overall shape which may differ from that of simple geometric figures such as circle, triangle or rectangle. For example, the multiple sections may give the pressure element a branched or ramified shape, as shown in FIG. 5, or a combination of shapes such as rectangle, square, semicircle, etc. In this way, it is advantageously possible, e.g., to cover the user's hand over a large area by the pressure element, but without depriving the hand of its function and mobility by providing the pressure element or restricting it excessively. In other words, the pressure element or its sections may be provided where they are more useful than disturbing.

Some or all embodiments according to the present invention may comprise one, several or all of the advantages mentioned above and/or below.

One advantage of the present invention may be to reduce or even eliminate pain, fatigue, stiffness and swelling of the hands and fingers by an automatic compressed air massage, in particular of the palms and finger joints. In this, the origin of this pain, fatigue, stiffness and/or swelling is irrelevant. They could, for example, be caused by daily work using the hands or by illness (e.g. rheumatoid arthritis).

When, in rheumatoid arthritis, the joints of the hand and fingers (often enough on both sides) become swollen, stiff and painful, a hand massage may provide relief, but a person is not always available to provide this service. By using the present invention, a hand massage may be performed automatically, thus saving time and manpower.

A further advantage of the present invention may be that a realistic massage sensation, such as for example by the physiotherapist may be achieved. With that, a patient or user may be flexibly enabled to have the limb massaged in addition to or instead of the usually only weekly physiotherapeutic treatments.

The present invention may be used to massage a wide variety of hand areas in different modes as required. This may represent a further advantage.

A further advantage of the present invention may be that in addition to relieving physical pain, the user may also improve their mental health. Patients of rheumatoid arthritis may suffer more often from depression due to the aforementioned symptoms.

The freedom of movement of the hands is maintained with the present invention, since in some embodiments for example the fingertips are not covered. Advantageously, the haptic perception of the fingertips is therefore present or not restricted. For example, when using the present invention, devices, in particular those for daily use, e.g., a coffee machine, a smartphone, a touchscreen or the like, may be operated. Handling other everyday objects, such as for example turning pages of magazines, newspapers or books, is also not restricted. The present invention is, therefore, very easily integratable into everyday life. This property may contribute to both patient comfort and patient safety.

Due to the individual adaptability of the present invention, in particular by a suitable choice of the type and number of tensioning or adjusting elements, both for the respective user (e.g. their size) as well as for the condition of the limb at the wearing time, a high level of wearing comfort is advantageously achieved.

A further advantage of the present invention may be that a high degree of hygiene is ensured due to the modular design and the resulting washability of the components of the device according to the present invention which are in contact with the skin of the part of the patient's body to be treated, without having to wash other components such as the motors, since they are removable for instance by hook-and-loop connections. This advantage may in turn indirectly contribute to patient safety.

Since 3D printing methods meanwhile represent a global technology that may also be used in a mobile manner, a further advantage of the present invention may be that it can be used worldwide without great effort, since the air cushions of the pressure element may be produced in this way.

A further advantage of the present invention may be that pressure may be exerted on the body areas to be treated, in particular, in order to loosen the joints or muscles, while the vibration may stimulate blood circulation in the respective body area. However, it has also been observed by the inventors that pressure, in particular intermittent pressure, may also promote blood circulation. Vibration is also advantageously associated with muscle relaxation and nerve stimulation and endorphin release with the known effects on the patient.

### BRIEF DESCRIPTION OF THE DRAWINGS

In the following, the present invention is described purely exemplarily with reference to the accompanying figures. In them, identical reference numerals denote identical or similar components. The following applies:

FIG. 1 shows schematically highly simplified a device according to the present invention in a first embodiment;

FIG. 2 shows schematically simplified a glove as an example of a casing of a device according to the present invention in a further embodiment with a view of the back of the hand;

FIG. 2a shows schematically simplified a glove as an example of a casing of a device according to the present invention in a further embodiment with a view of the palm of the hand;

FIG. 3 shows a compressed air system of a device according to the present invention in a further embodiment;

FIG. 3a shows the pressure element of FIG. 3, which is provided for the palm of the hand, laid out flat in a view from above;

FIG. 4 shows an example of an operating unit or an interface of a control device of a device according to the present invention in an exemplary embodiment;

FIG. 5 shows an example of a main air cushion of a further embodiment of the device according to the present invention, laid out flat and shown in a view from above;

FIG. 6 shows an example of a finger air cushion of a pressure element again in a further embodiment of the device according to the present invention, laid out flat and shown in a view from above; and

FIG. 7 shows a section of a main air cushion of a pressure element of an embodiment of the device according to the present invention, resting on the hand of a patient, in sectional view.

### DETAILED DESCRIPTION OF THE INVENTION

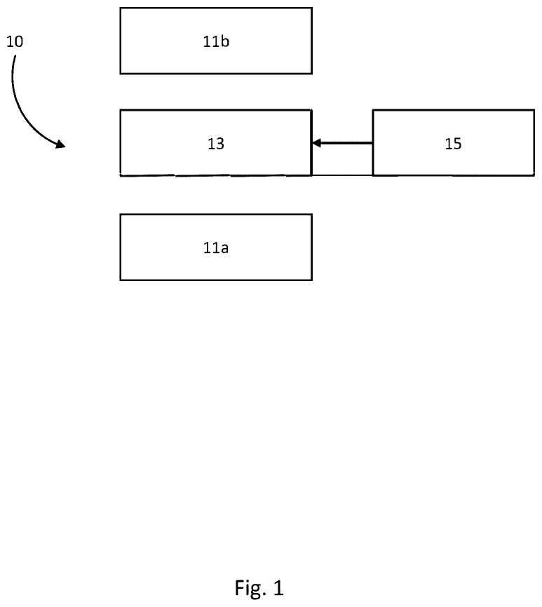

FIG. 1 shows schematically highly simplified a device 10 according to the present invention for use in arthritis, osteoarthritis, chronic inflammation and/or for reducing muscle pain and muscle tension with respect to a limb of a patient in a first embodiment.

In this, the device 10 comprises a casing 11 which in the example of FIG. 1 comprises a lower (in use inner) part of the casing 11a configured to receive the limb or a part thereof or to cover a part of the patient's body, or a part thereof, respectively. What is stated herein with regard to the limb may also apply to the body part in any embodiment, which is why for reasons of simplicity only the limb is mentioned in some cases. In addition to arms, hands, legs and feet, limbs may also encompass shoulder(s), head, back, upper body and/or other parts of the body.

The lower (in use inner) casing 11a may in particular have hygienic advantages, e.g. may be washable.

In some embodiments, the device 10 may be additionally or alternatively designed to be put on or applied to the patient's limb.

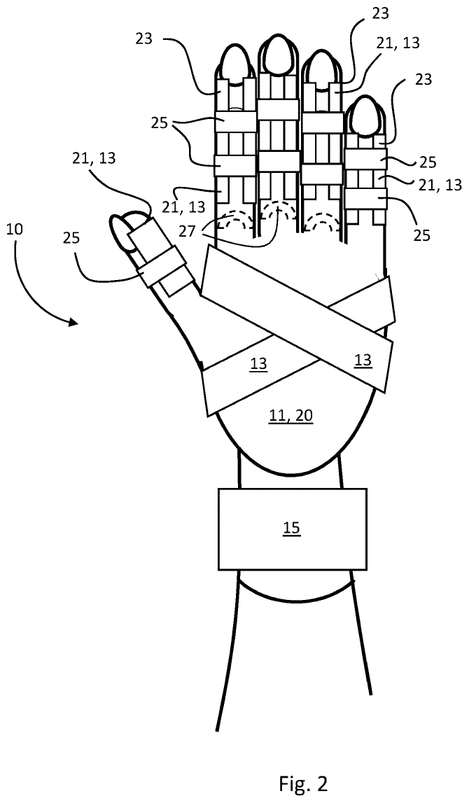

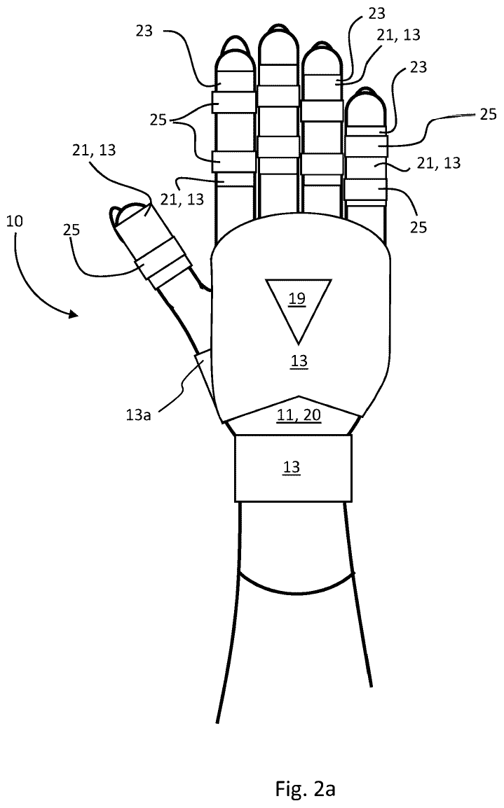

The casing 11 could, for example, be designed as a glove (see FIG. 2 for this), a sock or a sleeve.

Preferably, the casing 11 may be adapted to different sizes of a limb. For this purpose, it may comprise at least one tensioning element 25 (see also FIG. 2 for this).

By the at least one tensioning element 25, the device or parts thereof may be individually adapted to the patient during use. Differences in the dimensions of the patient's limbs, for example from a wearing time to another, e.g. in the form of swelling, weight loss or the like, may also be taken into account in this way without sacrificing wearing comfort.

A tensioning element 25 may be more or less elastic or not elastic at all.

The device 10 according to the present invention further comprises at least one pressure element 13, which in some embodiments herein may be designed, e.g., as an inflatable pressure pad, by which variable force or variable pressure may be applied to the limb during use of the device 10.

A control device 15, which is also comprised by the device 10 according to the present invention, may be configured or programmed to directly or indirectly prompt the pressure element 13 to apply force or pressure to the patient's limb which is or has been received in the casing 11 or to which the casing 11 is or has been applied.

A further (in use outer) part of the casing 11b is provided in the example of FIG. 1, for example to hold the pressure element 13 in place and/or to conceal it, which may offer optical advantages in particular.

FIG. 2 shows schematically simplified a glove 20 as an example of a casing 11 of a device 10 according to the present invention in a further embodiment with a view of the back of the hand.

In the Example of FIG. 2, the casing 11 of the device 10 is in the form of a fingerless glove 20 with fingerstalls 21, wherein a finger of the patient's hand is inserted respectively into each of the fingerstalls 21. Fingerless gloves, as mentioned herein, may separate the fingers from each other through glove material, unlike e.g. mittens. However, they do not cover the fingertips, distal phalanges or, in general terms, the distal end of one, several or all fingers (including the thumb).

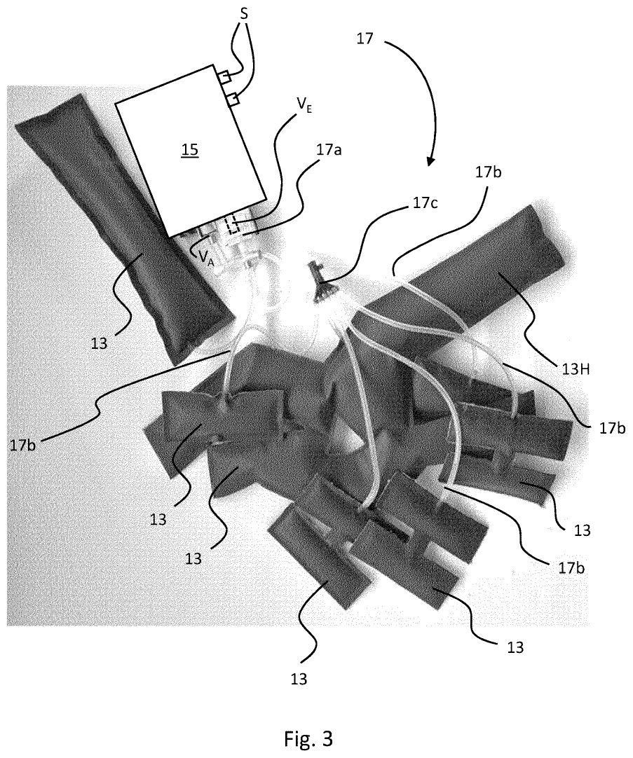

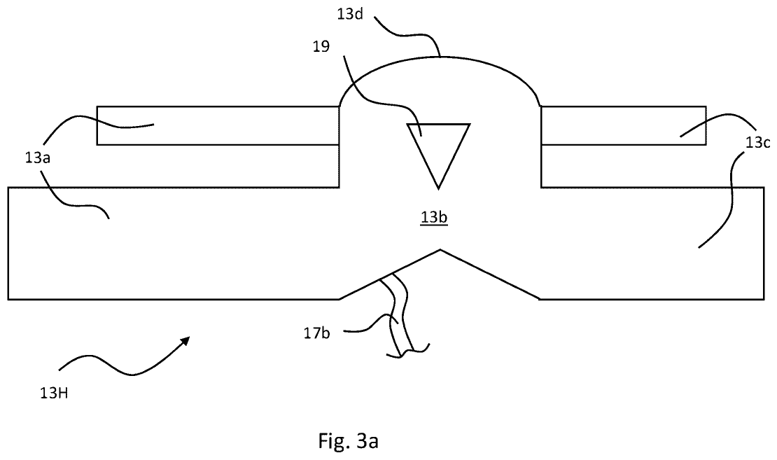

Pressure elements 13 may be received in the individual fingerstalls 21 (inside) or applied thereon (outside). In the example of FIG. 2 and FIG. 3, the pressure elements 13 lie on the outside of the casing 11. An upper (outer in use) part 11b of the casing (see FIG. 1) has been omitted for reasons of clarity.

The fingerstalls 21 are open at their distal end 23 with respect to an exterior of the glove 20, thus leaving the fingertips exposed. In the example of FIG. 2, the finger stalls 21 are thus open, and the fingernails protruding from the finger stalls 21 are visible.

In the example in FIG. 2, the device 10 also has optional tensioning elements 25, for example for each finger, in this example two respectively, here purely exemplarily only one on the thumb. They serve to vary the cross-sectional area of the respective fingerstall 21.

If the tensioning elements 25 are elastic, this can advantageously prevent accidental overloading in a corrective manner, in particular of the individual fingers. In some embodiments, the tensioning elements are not elastic, which makes it easier to achieve the desired pressure conditions, for example optionally on a single, specific finger.

In the example of FIG. 2, the fingerstalls 21 are not closed at their tip, i.e. distally.

Similarly, they are not closed along their longitudinal direction in every cross-section of the fingerstall 21. At least one circumference of the finger received in the fingerstall 21 is thus not completely covered with material of the fingerstall. This embodiment may also optionally provide a better fit and increased wearing comfort.

In other embodiments, the fingerstalls are optionally circumferentially closed, for example in the form of elastic textile tube sections.

Further pressure elements 13 may be arranged above, in or below a central section of the glove 20. In the example in FIG. 2, these are arranged crosswise over the palm and back of the hand. This arrangement is purely exemplary and is in no way to be understood as limiting. Other arrangements of the pressure elements 13 on the hand, for example by specially provided pockets, other holding devices or otherwise surrounded on both sides by casing material and/or a textile, are also encompassed by the present invention. In these embodiments, the pockets, holding devices, casing material and/or textile are preferably non-conductive.

In some embodiments, the casing 11 is optionally elastic and/or waterproof, but preferably still breathable.

In the example of FIG. 2, the casing 11 comprises further pull loops 27 or pull pockets or the like on the index, middle and ring finger (shown with dashed lines), which serve to engage with the hand not inserted in the device 10 before or during its use or after termination of use. The loops may be adjustable in length and may be used in particular for easier taking off and/or removing of the device according to the present invention from the patient's limb, for example by pulling them, such as with a finger. The position and number of loops 27 in the example of FIG. 2 is purely exemplary and is not to be understood as limiting.

Some or all of the lines, such as pneumatic and/or electrical lines, which are required in use to supply the pressure element(s) 13, may be protected from contact with the skin of the patient's treated limb by textiles or parts of the casing 11 or may be protected therethrough.

In some embodiments, the device 10 may further comprise a heating system and/or a cooling system. Heating elements and/or cooling elements may be provided, e.g., on the fingerstalls 21, over joints or elsewhere on the device or its casing.

The control device 15 is arranged on the wrist in the example of FIG. 2. This arrangement is also purely exemplary and is not to be understood as limiting; thus, the control device 15 may be provided e.g. completely physically separate from the device 10 and, e.g. only be connected wirelessly to the components of the device 10 which are to be controlled. The function of the control device 15 is discussed in more detail with regard to FIG. 3.

FIG. 2a shows schematically simplified a glove as an example of a casing of a device 10 according to the present invention in a further embodiment with a view of the palm of the hand.

Reference is made to the description with regard to FIG. 2. The following descriptions concern the differences between this embodiment and the embodiment of FIG. 2.

In the example of FIG. 2a, pressure elements 13 are arranged in or on a section of the glove 20 in order to be able to exert pressure on the metacarpal bones and/or the wrist. This arrangement is purely exemplary and is in no way to be understood as limiting. Pockets or other holding devices for the pressure elements 13 are also encompassed by the present invention.

A detailed description of the pressure element 13 for the metacarpal bones is found with reference to FIG. 3a, for which the through-opening 19 and the first section 13a are also described in more detail.

FIG. 3 shows a compressed air system 17 of a device 10 according to the present invention (see FIG. 2) in a further embodiment. The compressed air system 17 comprises several pressure elements 13, wherein the optional element 13H provided for the palm of the hand is described in more detail with regard to FIG. 3a. A control device 15 is also shown.

The control device 15 is programmed or configured to prompt the pressure element 13 to apply force or pressure to the patient's limb. For this purpose,, the control device 15 may be suitable and/or provided to control an inlet valve V_{E} and/or an outlet valve V_{A}, each of which is optionally in communication with the atmosphere. Inlet valve V_{E} and outlet valve V_{A} may be part of the compressed air system 17. Inlet valve V_{E} and outlet valve V_{A} may be controlled or controlled in a closed-loop manner in order to fill or empty an air cushion, as which the pressure element 13 may be designed, by air pressure, i.e. to allow the air pressure to be reduced. A compressor, an air pump or the like may be controlled by the control device 15 in order to build up air pressure.

It can also be seen from FIG. 3 that the control device 15 is connected, in particular releasably, to other components of the device 10, in this case the compressed air system 17, by a plug-in connection.

The compressed air system 17 comprises a pump 17a, which pumps air through or into lines 17b. Thereby, the air may be guided directly to a pressure element 13, or indirectly, i.e. initially to a distributor 17c, via which air is guided in a series of lines 17b to at least, or exactly one, pressure element 13 respectively. In some embodiments, a distributor 17c may ensure that always the same pressure is built up in all pressure elements 13 arranged downstream. In other embodiments, it is provided for to adjust the pressure of one, several or all pressure elements 13 individually. For this purpose, valves may be provided in some of the lines 17b, the optional distributor 17c may be adjustable, etc.

In some embodiments, the pressure element 13 may comprise a vibration system with optional vibration motors, e.g. piezo elements (not shown in FIG. 3), for instance alternatively or additionally. Some or all of the vibration motors may be arranged on the side of the casing facing the patient's palm during use.

Power connections S, by which the control device 15, or a voltage source comprising it, may be releasably connected to the vibration motors, to the pump for the pressure elements, etc., can also be seen in FIG. 3. Plugs that can be releasably connected to the power connections S may remain on the glove together with the conductive yarn. In some embodiments, they may also be washed.

FIG. 3a shows the pressure element 13H of FIG. 3, which is provided for the palm of the hand, laid out flat in a view from above.

First sections 13a, a second section 13b and third sections 13c are provided and/or suitable for completely or partially encompassing a hand, which is to be massaged with the device 10 according to the present invention (not shown in FIG. 3a), at the level of the palm of the hand. In this, the second section 13b comes to lie on the palm of the hand, while the first and third sections 13a and 13c are arranged on the back of the hand. For this purpose, in some embodiments, closure elements such as hook-and-loop fasteners or elements similar to the tensioning elements 25 described herein may be provided and used (not shown in FIG. 3a), i.e. in use, the pressure element 13H comprises both the palm and (at least parts of) the back of the hand.

In order to adapt well to the patient's hand, the pressure element 13H may be ergonomically designed. In the example of FIG. 3a, it comprises a convex edge 13d on the second section 13b, which can trace the upper edge of the palm of the hand pointing in the direction of the finger.

A through-opening 19 may be provided in the center of the second section 13b and may come to rest in the center of the palm of the hand when the device 10 is in use. If the pressure element 13H is inflated during use by the line 17b, the through-opening 19 advantageously enables the fingers to be bent, for instance when closing the hand, because there is no pressure-induced increase in the thickness of the device 10 at this point. In the example of FIG. 3a, the through-opening 19 has the shape of a triangle. This is purely exemplary and should not be understood as limiting. Other shapes of the through-opening 19, for example round, oval or rectangular or combinations of these shapes, are also encompassed by the present invention.

The design of the edge 13d opposite the convex edge 13H as viewed from the pressure element 13H may advantageously contribute to the free movement of the patient's wrist. In the example of FIG. 3a, it has a recess in the form of a triangle. Any other form of recess, for example an arcuate design, is also conceivable at this point and is encompassed by the present invention.

The first sections 13a and/or the third sections 13c are optional, as is the convex design of the edge 13d and/or the through-opening 19.

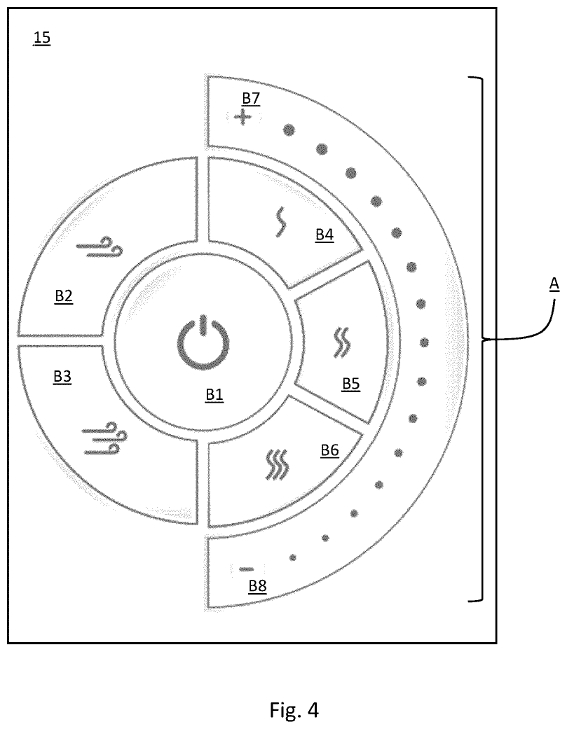

FIG. 4 shows an exemplary operating unit or interface of a control device 15 of a device 10 according to the present invention in an exemplary embodiment.

It can be seen from FIG. 4 that the control device 15 may be used to switch the device 10 on and off and to operate it in various modes. Furthermore, different modes and/or intensities for operating the device 10, in particular for controlling the pressure elements 13 or the vibration motors, may be selected.

For example, the following modes may be switched on the control unit or the interface of FIG. 4 using the buttons B1 to B8 or may be displayed using the display A:
B1On/Off
B2Air pressure mode medium pressure;
B3Air pressure mode higher pressure, for example by pumping three times and only then opening the outlet valve V_{A};
B4Vibration mode permanently on;
B5Vibration mode interval switching;
B6Vibration mode increasing and/or decreasing, e.g. 100% decreasing to 0% and then starting again from the beginning (100%) ;
B7Increasing the vibration intensity (+);
B8Reduction of the vibration intensity (−); i.e. a total of two buttons, e.g. buttons or push buttons, for increasing or reducing the intensity; and
ADisplay of the vibration intensity (e.g. by a series of (O) LEDs; the more (O) LEDs light up, the higher the vibration intensity)

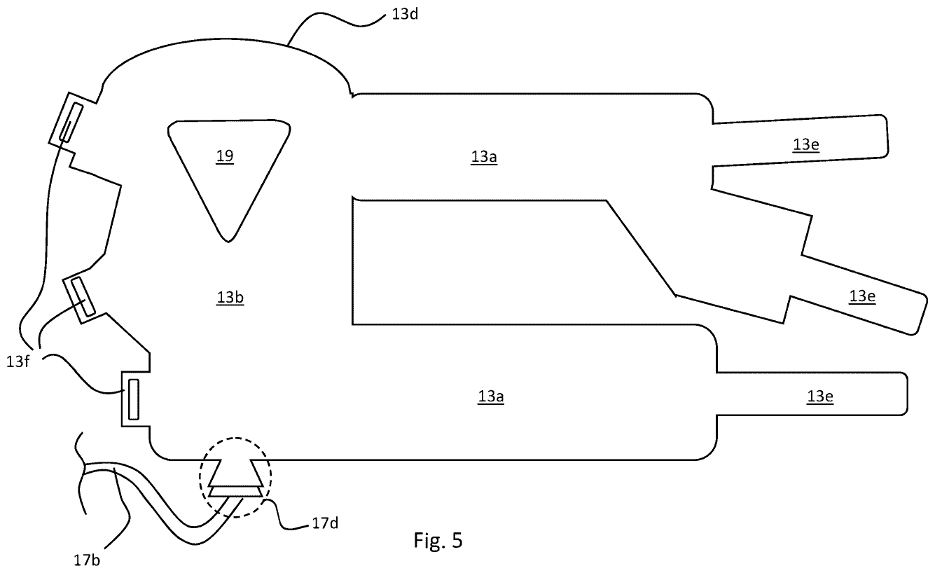

FIG. 5 shows an example of a main air cushion of a further embodiment of the device 10 according to the present invention, which is provided, as an example of a pressure element 13 or part thereof, to enclose the palm and back of the hand. The main air cushion is laid out flat in FIG. 5 and shown in a view from above.

Reference is made to the description with regard to the preceding figures.

In the example of FIG. 5, the pressure element 13 optionally has two first sections 13a and a second section 13b. They are preferably provided and/or suitable for completely or partially encompassing a hand, which is to be massaged with the device 10 according to the present invention (not shown in FIG. 3a), at the level of the palm of the hand. Here, the second section 13b, or large parts thereof, comes to lie on the palm of the hand, while the first sections 13a, or large parts thereof, are arranged on the back of the hand.

In this embodiment, the main air cushion comprises tensioning or adjusting elements, here as material strips 13e and connecting loops 13f, which may be releasably connected to each other by passing the material strips 13e through the connecting loops 13f and tightening them, similar to a pocket strap.

In the example in FIG. 5, the pressure element 13 lies against both the palm and (at least parts of) the back of the hand during use.

In the example of FIG. 5, one connecting loop is provided for each material strip 13e. By passing the material strip 13e through the connecting loop 13f and in this way closing, tightening or applying tension to the tensioning element or adjusting element, the pressure element 13 may be fastened or closed, for example so that it surrounds the part of the body to be treated.

Material strips 13e and connecting loops 13f, if provided, may be provided at any positions on the pressure element 13, preferably at the respective opposite ends of the pressure element 13 in the longitudinal direction (in FIG. 5 in the right-left direction). The material strips 13e may each have different angles to an imaginary longitudinal axis of the pressure element 13, which runs in the right-left direction in FIG. 5, and/or run parallel to such an axis. Preferably, the angles of the positions of the connecting loops 13f are arranged corresponding to these, e.g. in opposite directions, or vice versa. Such an arrangement may advantageously reflect or take into account the anatomy of the body part to be treated, in the example of FIG. 5, a hand.

In any embodiment disclosed herein, the material strips 13e may additionally or alternatively comprise portions of a hook-and-loop fastener (or Velcro), e.g. the male sections, and corresponding sections of the hook-and-loop fastener may be provided elsewhere, e.g. elsewhere on the main air cushion, e. g. the female sections.

In order to adapt well to the patient's hand, the pressure element 13 may be further ergonomically designed. In the example of FIG. 5, it comprises an edge 13d on the second section 13b, here optionally in a convex design, which may trace the upper edge of the palm of the hand pointing in the direction of the finger.

An optional through-opening 19 may be provided for example in the center of the second section 13b and may come to rest in the center of the palm of the hand when the device 10 is in use. If the pressure element 13 is inflated during use by the line 17b, the through-opening 19 advantageously enables the fingers to be bent, for example when closing the hand, because there is no pressure-induced increase in the thickness of the device 10 and/or no stiffening of the device 10 at this point.

In the example shown in FIG. 5, the through-opening 19 optionally has the shape of a triangle. This is purely exemplary and is not to be understood as limiting. Other shapes of the through-opening 19 are also encompassed by the present invention, see the description with regard to FIG. 3a. Several through-openings 19 may also be encompassed by the present invention. Their shapes may differ from one another.

The first sections 13a are optional, as is the convex design of the edge 13d and/or the through-opening 19.

A connection 17 d for a connector of the line 17b can be seen. The position of this connection on the main air cushion is purely exemplary. Other positions of the connection on the main air cushion are also encompassed by the present invention, as are differently designed embodiments of the connection.

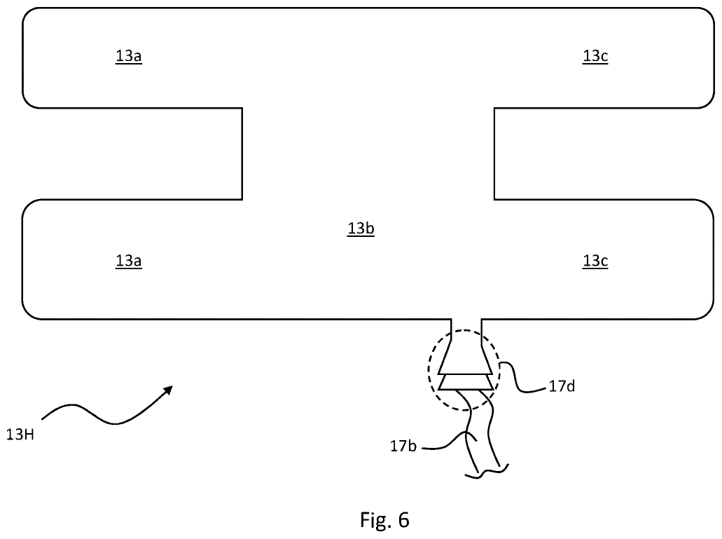

FIG. 6 shows exemplarily a finger air cushion of a pressure element 13 in a further embodiment of the device 10 according to the present invention. It may be provided to surround a single finger or thumb, or parts thereof, e.g. to enclose it completely or largely. The finger air cushion is laid out flat in FIG. 6 and shown in a view from above.

It may be attached from the inside or outside of the finger. While it optionally has an H-shape in FIG. 6, which is suitable for applying the finger air cushion to a finger while also avoiding the circumference of a joint of this finger, the finger air cushion for the thumb (which has one joint less than the finger) may have a square or rectangular shape, i.e. optionally not an H-shape.

Reference is made to the description with regard to the preceding figures.

In this embodiment, the pressure element 13 comprises two first sections 13a, a second section 13b and two third sections 13c, which are intended and/or suitable for fully or partially encompassing a finger. For this purpose, in some embodiments, closure elements such as hook-and-loop fasteners or elements similar to the tensioning elements or adjusting elements 25, 13e, 13f described herein may be provided and used (not specifically shown in FIG. 6).

At least one optional through-opening 19, not shown in FIG. 6, may optionally be provided in the center of the section or elsewhere.

The first sections 13a and/or the third sections 13c are optional. Their number is purely exemplary and is not to be understood as limiting. Any other number of sections is also encompassed by the present invention.

A connection 17d for a connector of the line 17b can be seen. The position of this connection on the finger air cushion is purely exemplary. Other positions of the connection on the finger air cushion are also encompassed by the present invention, as are differently designed embodiments of the connection, for example as described above for the main air cushion.

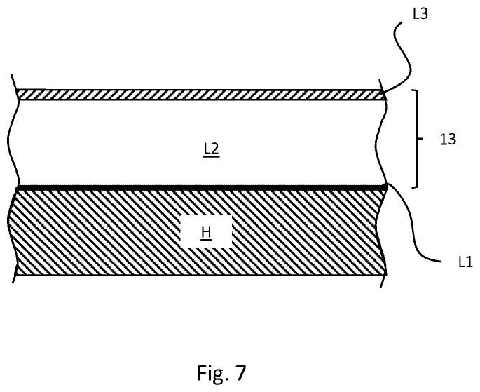

FIG. 7 shows a section of an air cushion, e.g. the main air cushion, of a pressure element 13 of a further embodiment of the device according to the present invention, resting on the outermost schematically outlined hand H of a patient.

The main air cushion comprises layers of different thickness and/or stiffness. The layer L3 of the pressure element 13 facing away from the patient's hand H or being furthest away from it is thicker and/or has a greater or higher stiffness than the layer L1 of the pressure element facing the skin of the patient's hand. For example, the layer L3 facing away from the hand H may consist of, or comprise, a TPU-coated textile, while the layer L1 facing the hand H may consist of, or comprise, a TPU film.

A layer of air L2 building up between these layers L1, L3 thus causes the lower layer L1 facing the hand H to expand more than the upper layer L3 of the pressure element 13 facing away from the patient's hand H. This allows the pressure on the patient's hand H to be increased or ensured, while the external dimensions of the device 10 remain sufficiently constant, so that the pressure acts in the direction of the hand and is not reduced by excessive volume changes in the layer of air L2.

### List of Reference Numerals

10 device
11 casing
11a lower (during use inner) part of the casing
11b upper (during use outer) part of the casing
13 pressure element
13H pressure element for the palm
13a first section of the pressure element
13b second section of the pressure element
13c third section of the pressure element
13d concave edge of the second section
13e material strips
13f connecting loops
15 control device
17 compressed air system
17a pump
17b lines
17c distributor
17d connection for air line with connector
19 through-opening
20 glove
21 fingerstall
23 distal end
25 tensioning element
27 pull loops
A display for the vibration intensity
B1 bis B7 buttons of the control unit or of the interface
H hand (of the patient)
L1 layer of the pressure element facing the patient's skin
L2 layer of the pressure element; air layer
L3 layer of the pressure element facing away from the patient's skin
V_{E} inlet valve
V_{A} outlet valve
S power access; plug connection

1. A device for use in arthritis, osteoarthritis, chronic inflammation and/or for reducing muscle pain and muscle tension with respect to a limb or body part (for short: limb) of a patient, wherein the device comprises:
a casing configured for receiving the limb, or a part thereof, of the patient;
at least one pressure element for applying force and/or pressure to the limb during use of the device; and
a control device for prompting force, vibration, stimulation or pressure to be applied to the limb by the pressure element.

2. The device according to claim 1, wherein the casing is a glove with fingerstalls for a plurality of fingers of the patient.

3. The device according to claim 2, wherein one or several of the fingerstalls are open at their distal end with respect to an exterior of the glove.

4. The device according to claim 2, comprising at least one tensioning element for varying the cross-sectional area of at least one of the fingerstalls and/or for opening at least one of the fingerstalls.

5. The device according to claim 4, wherein the tensioning element is elastic.

6. The device according to claim 2, wherein at least one of the fingerstalls is not closed along its longitudinal direction in every cross-section.

7. (canceled)

8. The device according to claim 1, wherein the at least one pressure element is a compressed air system with at least one air cushion, or is comprised by such.

9. The device according to claim 8, wherein the compressed air system or the pressure element comprises two or more, in particular physically and/or fluidically, separate air cushions, wherein at least one of the air cushions comprises at least one through-opening.

10. The device according to claim 8, wherein the pressure element or the compressed air system comprises at least one main air cushion and at least one finger air cushion.

11. (canceled)

12. The device according to claim 8, wherein at least one of the air cushions comprises layers of different thickness and/or stiffness or is limited thereby.

13. The device according to claim 1, wherein the pressure element is or comprises a vibration system, wherein the vibration system comprises vibration motors.

14. (canceled)

15. (canceled)

16. The device according to claim 1, wherein the pressure element is arranged in a pocket of the casing, or is otherwise surrounded on both sides by casing material and/or a textile, in particular non-conductive.

17. The device according to claim 1, wherein the pressure element is provided releasably connected to the casing or another section of the device, in particular by a provided hook-and-loop connection.

18. The device according to claim 1, wherein different modes for operating the pressure element may be selected via the control device.

19. The device according to claim 18, wherein the control device is configured to activate individual components of the pressure element successively in terms of time.

20. The device according to claim 1, wherein the control device and/or the pressure element are configured to effect or prompt, in use, a pressure wave towards the patient's heart.

21. (canceled)

22. The device according to claim 1, wherein the casing comprises loops or pull loops for engagement with the hand not placed or inserted in the device during its use.

23. (canceled)

24. The device according to claim 1, further comprising a heating system or cooling system.

25. The device according to claim 1, wherein the control device or parts thereof and/or the pressure element are provided with the remaining part of the device in a releasable manner, in particular by a plug-in connection.

26. (canceled)

27. The device according to claim 1, wherein at least one microphone is provided for voice control of the device or of sections thereof.
